(19) United States
(12) Patent Application Publication
(10) Pub. No.: US 2026/0030810 A1
(43) Pub. Date: Jan. 29, 2026

(54) IMAGE PROCESSING METHOD AND APPARATUS, DEVICE, AND STORAGE MEDIUM

(71) Applicant: Beijing Zitiao Network Technology Co., Ltd., Haidian District, Beijing (CN)

(72) Inventors: Jiaxin MA, Beijing (CN); Chun LIU, Beijing (CN); Wei PENG, Beijing (CN); Ruimeng WANG, Beijing (CN)

(21) Appl. No.: 18/875,402

(22) PCT Filed: Jun. 7, 2023
(86) PCT No.: PCT/CN2023/098807

§ 371 Date: Dec. 16, 2024

(30) Foreign Application Priority Data
Jun. 17, 2022 (CN) 202210693158.6

(51) Int. Cl. G06T 11/60

(52) U.S. Cl. CPC G06T 11/60; G06T 2200/24

(57) ABSTRACT

The embodiments of the present disclosure provide an image processing method and apparatus, a device, a medium and a product. The method includes: obtaining at least two original images; displaying the at least two original images on a current screen in a preset manner, and sending the two original images to a server, such that the server performs fusion processing on the at least two original image s; and receiving a first target image returned by the server, and displaying the first target image on the current screen, where the first target image is an image obtained after the server has performed the fusion processing on the at least two original images.

The present disclosure claims the priority from the CN patent application No. 202210693158.6 filed with the China National Intellectual Property Administration (CNIPA) on Jun. 17, 2022, which is incorporated herein by reference in its entirety.

### FIELD

Embodiments of the present disclosure generally relate to the technical field of image processing, and more specifically, to an image processing method and apparatus, a device, and a storage medium.

### BACKGROUND

Nowadays, mobile terminals are essential tools in users' entertainment. A user may use a mobile terminal to perform a variety of image processing. According to the related technologies, most of the image processing is implemented by running local algorithms on clients. Limitations of hardware configuration of the mobile terminal lead to a low image processing efficiency, and a poor accuracy of the processed image, which affects the image processing effect.

### SUMMARY

Embodiments of the present disclosure provide an image processing method and apparatus, a device, a medium and a product, where a plurality of images are sent to a server for fusion, which cannot only reduce the data processing load on a client, but can also improve the image fusion effect.

In a first aspect, the embodiments of the present disclosure provide an image processing method, comprising:
obtaining at least two original images;
displaying the at least two original images on a current screen in a preset manner, and sending the two original images to a server, such that the server performs fusion processing on the at least two original images; and
receiving a first target image returned by the server, and displaying the first target image on the current screen, wherein the first target image is an image obtained after the server has performed the fusion processing on the at least two original images.

In a second aspect, the embodiments of the present disclosure further provide an image processing apparatus, comprising:
an original image obtaining module configured to obtain at least two original images;
an original image sending module configured to display the at least two original images on a current screen in a preset manner, and send the two original images to a server, such that the server performs fusion processing on the at least two original images; and
a first target image display module configured to receive a first target image returned by the server, and display the first target image on the current screen, wherein the first target image is an image obtained after the server has performed the fusion processing on the at least two original images.

In a third aspect, the embodiments of present disclosure further provide an electronic device, comprising:
one or more processors; and
a memory configured to store one or more programs;
wherein the one or more programs, when executed by the one or more processors, cause the one or more processors to implement the image processing method according to the embodiments of the present disclosure.

In a fourth aspect, the present disclosure further provides a storage medium having computer executable programs stored thereon, wherein the computer executable programs, when executed by a computer processor, implement the image processing method according to the embodiments of the present disclosure.

### BRIEF DESCRIPTION OF THE DRAWINGS

Throughout the drawings, the same or similar reference symbols represent the same or similar components. It would be appreciated that the drawings are provided illustratively, where the components and elements are not necessarily drawn to scale.

FIG. 1 illustrates a flowchart of an image processing method provided by embodiments of the present disclosure;

FIG. 2a illustrates a schematic diagram of selecting, by a user, local images provided by embodiments of the present disclosure;

FIG. 2b is a diagram of an example of displaying original images on a screen provided by embodiments of the present disclosure;

FIG. 2c is a diagram of an example of displaying original images on a screen provided by embodiments of the present disclosure;

FIG. 2d is a diagram of an example of displaying a first target image provided by embodiments of the present disclosure;

FIG. 3 is a schematic diagram of a structure of an image processing apparatus provided by embodiments of the present disclosure; and

FIG. 4 is a schematic diagram of a structure of an electronic device provided by embodiments of the present disclosure.

### DETAILED DESCRIPTION OF EMBODIMENTS

Reference now will be made to the drawings to describe in detail the embodiments of the present disclosure. Although the drawings illustrate some embodiments of the present disclosure, the present disclosure can be implemented in various forms. It would be appreciated by those skilled in the art that the drawings and embodiments of the present disclosure are provided exemplarily.

It is to be understood that respective steps in the implementations of the method according to the present disclosure may be performed in different orders and/or performed in parallel. In addition, the method implementations may include additional steps and/or omit steps included herein. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It is to be noted that the terms “first,” “second” and the like mentioned in the present disclosure are only used to distinguish different apparatuses, modules or units, rather than limit an order of functions performed by the apparatus, module or unit or limit interdependence.

It is to be noted that the terms “one” and “a plurality of” mentioned in the present disclosure are illustrative, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers, or storage media that perform operations of the technical solution of the present disclosure.

As an optional implementation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

The data (including data per se, and acquisition or application of the data) involved in the present technical solution should comply with the provisions of the corresponding laws and regulations as well as relevant stipulations.

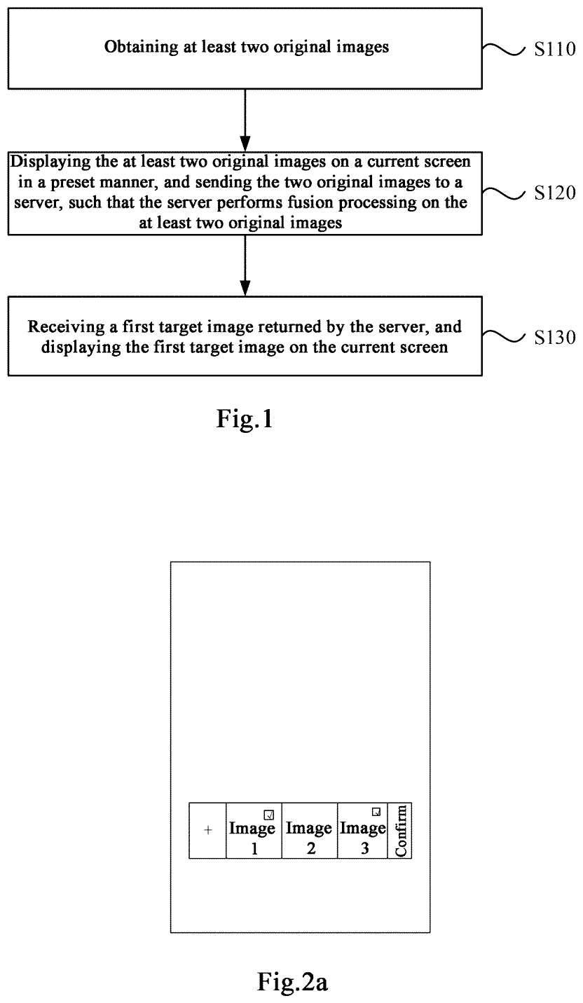

FIG. 1 is a flowchart of an image processing method provided by embodiments of the present disclosure. The embodiments of the present disclosure can be applied to a scenario of fusing a plurality of images. The method can be performed by an image processing apparatus, which can be implemented in the form of software and/or hardware, or by an electronic device that may be a mobile terminal, a Personal Computer (PC) or server, or the like.

As shown therein, the method includes:
S110: obtaining at least two original images.

The original image may be an image to be processed. Obtaining at least two original images may be implemented by: frame capturing and/or uploading from a local device, i.e., the at least two original images are both acquired by frame capturing, or by uploading from a local device, or partly by frame capturing and partly by uploading from a local device.

Alternatively, obtaining at least two original images may include: upon detecting a first operation triggered by a user, performing frame-capture processing on the current screen at least twice in succession, so as to obtain at least two original images; or upon detecting that a user selects at least two original images from a local device and triggers a second operation, using the at least two original images selected by the user as the obtained at least two original images.

The first operation may be an operation triggering the terminal device to perform frame-capture processing on the current screen, which may include, for example, single-clicking on the screen, double-clicking on the screen, detecting that a user makes a preset gesture or posture, acquiring a voice signal containing a preset keyword, or trigging, by a user, frame capturing by clicking on a control button configured to trigger frame capturing on the interface. Frame capturing may also be referred to as screenshot, which is implemented on a content displayed on the current screen by calling a frame capturing function, to obtain an original image. Alternatively, triggering frame-capture processing may also be implemented by countdown, i.e., when the terminal enters the image processing tool, countdown numbers “321” start to be displayed on the interface, and upon the end of the countdown, a frame-capture operation is performed; then, the countdown numbers “321” are re-displayed, and at the end of the countdown, a new frame-capture operation is performed; the action is repeated until the number of the frame-capture operations reaches a preset value. By way of example, when a user enables an image processing tool via a terminal device, the terminal device displays in real time an image currently captured by the camera on the current screen, or plays a video file acquired from the local database or network database on the current interface. Upon detecting that the first operation triggered by the user, the terminal device performs frame-capture processing on the current screen at least twice in succession, so as to obtain at least two original images.

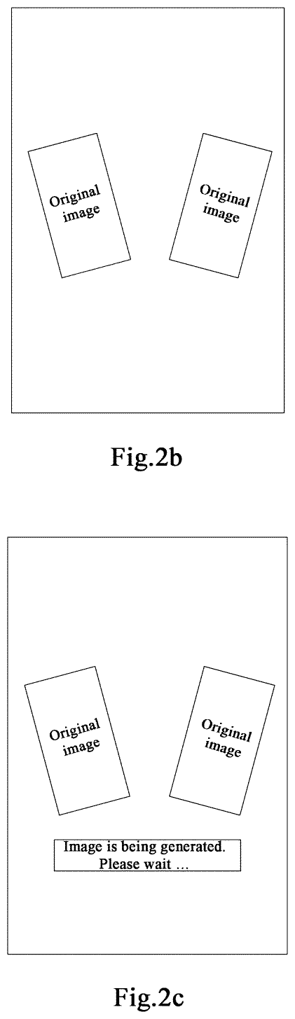

The second operation may be an operation for confirming the at least two original images selected by the user. In the embodiment, when a user enables an image processing tool via the terminal device, a button of adding local images is displayed on the interface; after the user clicked on the button, the terminal displays images stored locally on the current interface for the user's selection; upon detecting that the user selects at least two original images therefrom and triggers the second operation, the at least two original images selected by the user are used as the obtained at least two original images. By way of example, FIG. 2a is a schematic diagram of selecting, by a user, local images according to this embodiment. As shown therein, the user clicks on the button “+,” the terminal displays the images stored locally on the current interface; assumed that the user selects Image 1 and Image 3 as the original images obtained ultimately. In the embodiment, the original images are obtained by frame capturing or selecting from the local device, making the original images more diversified.

Alternatively, obtaining the at least two original images includes: during performing the frame-capture processing on the current screen at least twice in succession, in response to detecting that the user selects at least two original images from the local device and triggers the second operation, stopping the frame-capture processing, and deleting images obtained through the frame capturing processing, and using the at least two original images selected by the user as the obtained at least two original images.

The process of performing the frame-capture processing on the current screen at least twice in succession may be read as a time period during which the frame-capture processing on the current screen has been started but not completed. By way of example, in the process where the terminal has begun to capture frames on the current screen but not completed the capturing, if detected that the user selects at least two original images from the local device and triggers the second operation, the terminal is controlled to stop the ongoing frame-capture processing on the current screen and delete the images that have been obtained through frame capturing, and the at least two original images selected by the user are used ultimately as the obtained at least two original images.
S120: displaying the at least two original images on the current screen in a preset manner, and sending the two original images to a server, such that the server performs fusion processing on the at least two original images.

The preset manner may include displaying in the manner of playing an animation, or displaying statistically for a preset duration. The manner of displaying the at least two original images on the current screen may be set as required.

Alternatively, displaying the at least two original images on the current screen in the preset manner may include: obtaining a playing animation respectively corresponding to the at least two original images; and displaying the at least two original images on the current screen based on the playing animation.

The playing animation consists of a plurality of frames, where each frame of the animation contains motion information and display information of the original image on the screen. Wherein, the motion information includes position information and rotation information, and the display information includes size information and transparency information. The position information may be read as coordinates of a position of the center point of the original image in the current frame, and the rotation information may be read as an angle between a horizontal side of the original frame and the horizontal or vertical direction, or an angle between a vertical side of the original image between the horizontal or vertical direction. The size information may be a length and a height of the original image, and the transparency information may be read as a display transparency of the original image.

In this embodiment, the transparency information may be a value between 0 and 1, where 0 is totally transparent, and 1 is completely opaque. The transparency information of the original image in the playing animation can be determined based on an overlap of a plurality of original images. By way of example, if multiple original images do not overlap, the transparency information of the respective original images is all 1; and if multiple images overlap, the transparency or transparencies of one or more original images are reduced. For example, a correspondence relationship between an overlap and an adjustment amount of the transparency can be pre-built, and the adjustment amount is thus determined based on the overlap; the transparency or transparencies of one or more original images are reduced based on the adjustment amount.

In this embodiment, the motion information and the display information of the original image in the playing animation may be set arbitrary, or a plurality of candidate animations may be preset for users' selection. By way of example, two original images are taken as an example. Playing an animation corresponding to the two original images may include: two original images fly into the current screen from left and right upper boundaries of the screen, respectively; when the two original images meet on the screen, the two original images move towards the center of the screen; when arriving at the center of the screen, the two original images move in opposite directions; the two original images become overlapped gradually; playing the animation is ended until overlapping the two original images are completed. By way of example, FIG. 2b is a diagram of an example of displaying original images on the screen according to the present embodiment. As shown therein, the left original image is inclined leftwards, and the right original image is inclined rightwards. In the present embodiment, at least two original images are displayed on the current screen according to a playing animation, thus making the display on the screen more diversified while improving the user experience.

Alternatively, displaying the at least two original images on the current screen in the preset manner includes: obtaining preset materials; and displaying statically the at least two original images based on a first transparency, and displaying the preset materials on the current screen based on a second transparency.

Wherein, the first transparency is greater than the second transparency, i.e., the original image is not fully covered by the preset material, and can be seen through the preset material. The preset material may be a video file which consists of a sequence of material images, i.e., a plurality of material images. The material images may be images preset by a developer, or may be a sequence of material images for timing, for example, a sequence of material images in the form of a progress bar, a sequence of material images in the form of a countdown, or a sequence of material images in the combined form of a countdown and a progress bar. In the embodiment, at least two original images and the preset material can be displayed simultaneously on the current screen, and in the case, a duration of displaying statically the two original images on the current screen is dependent on a duration corresponding to the preset material. By way of example, FIG. 2c is a diagram of an example of displaying original images on a screen according to the present embodiment. As shown therein, the two original images are displayed statically on the current screen, and the preset material is a sequence of images generated from a segment of prompt information. In this embodiment, the preset material and the at least two original images are displayed simultaneously on the current screen, thus making the display on the screen more diversified while improving the user experience.

In this embodiment, sending the at least two original images to the server, such that the server performs the fusion processing on the at least two original images, includes: sending the at least two original images carrying an algorithm identifier to the server, such that the server calls a target fusion algorithm based on the algorithm identifier, so as to perform the fusion processing on the at least two original images using the target fusion algorithm.

Wherein, the algorithm identifier may be formed by information such as an algorithm name, an algorithm storage address, and the like. The target fusion algorithm may be a constructed neural network model, for example, Generative Adversarial Nets (GAN), and the like. In this embodiment, different fusion functions correspond to different fusion algorithm, an image processing tool can set one or more fusion algorithms on the server, and the user selects the desired fusion algorithm. By way of example, the fusion algorithm may fuse at least two facial images into a “baby” image, or may fuse at least two facial images into a virtual facial image, or may fuse at least two images differing in style into an image of a new style, or the like. The function of the fusion algorithm may be set as required.

In the embodiment, due to the impact of the network status, the time required for operating the target fusion algorithm, and an uncertain time when the server returns a first target image, after the client has sent the two original images to the server, the at least two original images can be displayed on the current screen in a preset manner within a time period from transmission of the original images to receipt of the first target image. That is, displaying the at least two original images in the preset manner is performed concurrently with sending the at least two original images to the server. In this embodiment, in the process of sending the at least two original images to the server for fusion, a processing time is reserved for the target fusion algorithm of the server by displaying the at least two original images on the current screen in the preset manner, which can improve the flexibility of interface interaction.

In the embodiment, when sending the at least two original images to the server, the method further includes a step of: calling a locally preset algorithm to process any of the at least two original images, so as to obtain a second target image.

By way of example, after the at least two original images are obtained, the target fusion algorithm of the server and the locally preset algorithm of the local client are called concurrently to process the at least two original images, so as to obtain a first target image output by the target fusion algorithm and a second target image output by the locally preset algorithm. In the present embodiment, if the server returns in time the first target image to the client, the client displays the first target image; if the server fails to return in time the first target image to the client, the client displays the second target image. As the target fusion algorithm of the server and the locally preset algorithm of the local client are called concurrently to process the at least two original images, both the high-precision computing capability of the server and the processing efficiency of the client are taken into account herein.

Wherein, the locally preset algorithm corresponds to the target fusion algorithm. The locally preset algorithm may be a constructed neural network model, for example, Generative Adversarial Nets (GAN), and the like. That the locally preset algorithm corresponds to the target fusion algorithm may be read as: the locally preset algorithm and the target fusion algorithm are identical with respect to function, and the locally preset algorithm has a lower precision and occupies fewer system resources than the target fusion algorithm. By way of example, assumed that the target fusion algorithm of the server can fuse at least two facial images into a “baby” image, the locally preset algorithm can convert an original image into a “baby” image. In this embodiment, calling the locally preset algorithm to process any of the at least two original images is performed concurrently with sending the at least two original images to the server. In this embodiment, when the client has not received the first target image returned by the server within a preset duration, the second target image output by the locally preset algorithm is displayed on the current screen, thus avoiding the case of no image being displayed on the current screen, and improving the user experience.
S130: receiving a first target image returned by the server, and displaying the first target image on the current screen.

Wherein, the first target image is an image obtained after the server has performed the fusion processing on the at least two original images. In this embodiment, after received from the server, the first target image can be displayed on the current screen.

Displaying the first target image on the current screen may be: displaying separately the first target image on the current screen, or displaying concurrently the first target image and the at least two original images on the current screen. In this embodiment, the first target image may be displayed in full screen on the current screen, or may be displayed on the current screen in a size less than the screen size. By way of example, FIG. 2d is a diagram of an example of displaying the first target image according to the present embodiment. As shown therein, the first target image and the at least two original images are concurrently displayed on the current screen.

Alternatively, after displaying the two original images on the current screen in the preset manner, the method further includes a step of: in response to failing to receive the first target image returned by the server, displaying the second target image on the current screen; or in response to failing to receive the first target image returned by the server, displaying the preset information on the current screen.

Wherein, the preset information may be information indicating that the first target image returned by the server has not been received, for example, “Processing Failed,” and the like. In this embodiment, when the client has not received the first target image returned by the server within a preset duration, the preset information is displayed on the current screen, to avoid the case of no content being displayed on the current screen, which functions to prompt the user, thereby improving the user experience.

The technical solution according to the embodiments of the present disclosure includes: obtaining at least two original images; displaying the at least two original images on a current screen in a preset manner, and sending the two original images to a server, such that the server performs fusion processing on the at least two original images; and receiving a first target image returned by the server, and displaying the first target image on the current screen, where the first target image is an image obtained after the server has performed the fusion processing on the at least two original images. The image processing method according to the embodiments of the present disclosure includes sending at least two original images to a server for fusion, to thus reduce the data processing load on the client while improving the image fusion effect.

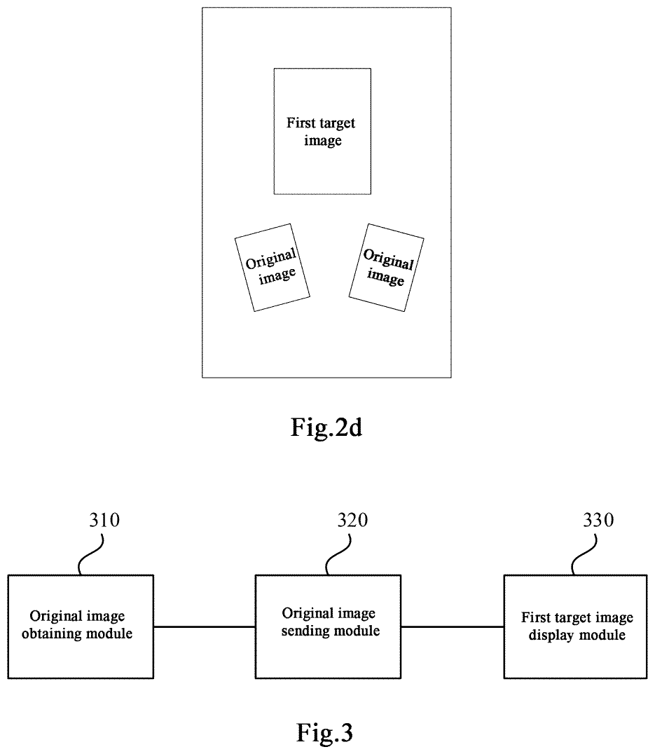

FIG. 3 is a schematic diagram of a structure of an image processing apparatus. As shown therein, the apparatus includes:
an original image obtaining module 310 configured to obtain at least two original images;
an original image sending module 320 configured to display the at least two original images on a current screen in a preset manner, and send the two original images to a server, such that the server performs fusion processing on the at least two original images; and
a first target image display module 330 configured to receive a first target image returned by the server, and display the first target image on the current screen, where the first target image is an image obtained after the server has performed the fusion processing on the at least two original images.

Alternatively, the original image obtaining module 310 is configured to obtain the at least two original images by:
upon detecting a first operation triggered by a user, performing frame-capture processing on the current screen at least twice in succession, so as to obtain at least two original images; or
upon detecting that a user selects at least two original images from a local device and triggers a second operation, using the at least two original images selected by the user as the obtained at least two original images.

Alternatively, the original image obtaining module 310 is configured to obtain the at least two original images by:
during performing the frame-capture processing on the current screen at least twice in succession, in response to detecting that the user selects at least two original images from the local device and triggers the second operation, stopping the frame-capture processing, and deleting images obtained through the frame capturing processing, and using the at least two original images selected by the user as the obtained at least two original images.

Alternatively, the original image sending module 320 is configured to send the at least two original images to the server, such that the server performs the fusion processing on the at least two original images by:
sending the at least two original images carrying an algorithm identifier to the server, such that the server calls a target fusion algorithm based on the algorithm identifier, so as to perform the fusion processing on the at least two original images using the target fusion algorithm.

Alternatively, the apparatus further includes: a second target image obtaining module configured to:
call a locally preset algorithm to process any of the at least two original images, so as to obtain a second target image, where the locally preset algorithm corresponds to the target fusion algorithm.

Alternatively, the apparatus further includes: a second target image obtaining module configured to:
in response to failing to receive the first target image returned by the server, display the second target image on the current screen.

Alternatively, the apparatus further includes: an original image display module configured to:
obtain a playing animation respectively corresponding to the at least two original images; and
display the at least two original images on the current screen based on the playing animation.

Alternatively, the original image display module is configured to display the at least two original images on the current screen in the following manner:
displaying the at least two original images on the current screen based on the motion information and the display information, where the motion information comprises position information and rotation information, and the display information comprises size information and transparency information.

Alternatively, the original image display module is further configured to display the at least two original images on the current screen in the preset manner by:
obtaining preset materials; and
displaying statically the at least two original images based on a first transparency, and displaying the preset materials on the current screen based on a second transparency, where the first transparency is greater than the second transparency.

Alternatively, the apparatus further comprises: a preset information display module configured to:
in response to failing to receive the first target image returned by the server, display preset information on the current screen.

The image processing apparatus provided by the embodiments of the present disclosure can perform the image processing method provided by any of the embodiments of the present disclosure, which includes functional modules corresponding to the method and can achieve the corresponding advantageous effects.

It is worth noting that the respective units and modules included in the apparatus are only divided according to the function logic, which are not confined to the above division as long as they can implement the respective functions. In addition, names of the plurality of functional units are employed only for differentiation from one another, without suggesting any limitation to the protection scope of the embodiments of the present disclosure.

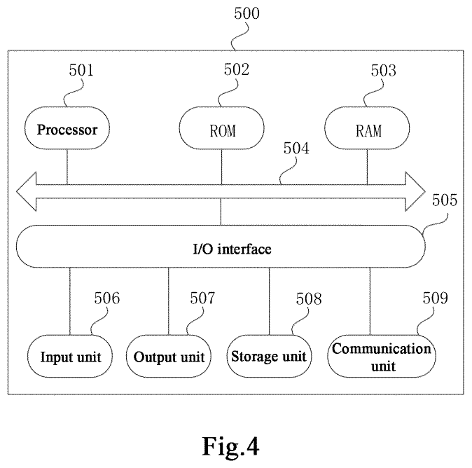

FIG. 4 is a schematic diagram of a structure of an electronic device provided by the embodiments of the present disclosure. Reference now will be made to FIG. 4 that illustrates a structure of an electronic device 500 (e.g. a terminal device or server in FIG. 4) adapted to implement the embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital television (TV), a desktop computer or the like. The electronic device as shown in FIG. 4 is provided merely as an example.

As shown therein, the electronic device 500 may include a processor (e.g. a central processor, a graphics processor or the like) 501, which can execute various acts and processing based on programs stored in a Read Only Memory (ROM) 502 or a program loaded from a memory 508 to a Random Access Memory (RAM) 503. RAM 503 stores therein various programs and data required for operations of the electronic device 500. The processor 501, the ROM 502 and the RAM 503 are connected to one another via a bus 504. An input/output (I/O) interface 505 is also connected to the bus 504.

Typically, the following units may be connected to the I/O interface 505: an input unit 506 including, for example, a touchscreen, a touch pad, a keyboard, a mouse, a camera, a microphone, an accelerometer, a gyroscope and the like; an output unit 507 including, for example, a Liquid Crystal Display (LCD), a loudspeaker, a vibrator and the like; a memory 508 including, for example, a tape, a hard drive and the like; and a communication unit 509. The communication unit 509 can allow wireless or wired communication of the electronic device 500 with other devices to exchange data. Although FIG. 4 shows the electronic device 500 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising a computer program carried on a computer readable medium, the computer program containing program code for performing the method as in the flowchart. In those embodiments, the computer program may be downloaded and installed from a network via the communication unit 509, or may be installed from the memory 508, or may be installed from the ROM 502. The computer program, when executed by the processor 501, performs the above-described functions defined in the method according to the embodiments of the present disclosure.

The electronic device provided by the embodiments of the present disclosure belongs to the same invention conception as the image processing method provided by the above-mentioned embodiments. For the technical details not exhausted here, see the above-mentioned embodiments, and these embodiments can achieve the same advantageous effect as the above-mentioned embodiments.

The embodiments of the present disclosure provide a computer storage medium having a computer program stored thereon, where the program, when executed by a processor, implements the image processing method provided by the above-mentioned embodiments.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries a program which, when executed by the electronic device, cause the electronic device to: obtain at least two original images; display the at least two original images on a current screen in a preset manner, and send the two original images to a server, such that the server performs fusion processing on the at least two original images; and receive a first target image returned by the server, and display the first target image on the current screen, where the first target image is an image obtained after the server has performed the fusion processing on the at least two original images.

Computer program codes for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the functionality and operation of possible implementations of methods, apparatus and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The units described in the embodiments of the present disclosure may be implemented by software or hardware. Wherein, the designation of a module or unit does not in some cases constitute a limitation to the unit itself. For example, the first obtaining unit may be described as “a unit for obtaining at least two Internet Protocol addresses.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

According to one or more embodiments of the present disclosure, there is provided an image processing method, comprising:
obtaining at least two original images;
displaying the at least two original images on a current screen in a preset manner, and sending the two original images to a server, such that the server performs fusion processing on the at least two original images; and
receiving a first target image returned by the server, and displaying the first target image on the current screen, wherein the first target image is an image obtained after the server has performed the fusion processing on the at least two original images.

In an embodiment, obtaining the at least two original images comprises:
upon detecting a first operation triggered by a user, performing frame-capture processing on the current screen at least twice in succession, so as to obtain at least two original images; or
upon detecting that a user selects at least two original images from a local device and triggers a second operation, using the at least two original images selected by the user as the obtained at least two original images.

In an embodiment, obtaining the at least two original images comprises:
during performing the frame-capture processing on the current screen at least twice in succession, in response to detecting that the user selects at least two original images from the local device and triggers the second operation, stopping the frame-capture processing, and deleting images obtained through the frame capturing processing, and using the at least two original images selected by the user as the obtained at least two original images.

In an embodiment, sending the at least two original images to the server, such that the server performs the fusion processing on the at least two original images, comprises:
sending the at least two original images carrying an algorithm identifier to the server, such that the server calls a target fusion algorithm based on the algorithm identifier, so as to perform the fusion processing on the at least two original images using the target fusion algorithm.

In an embodiment, after sending the at least two original images to the server, the method further comprises:
calling a locally preset algorithm to process any of the at least two original images, so as to obtain a second target image, wherein the locally preset algorithm corresponds to the target fusion algorithm.

In an embodiment, after displaying the at least two original images on the current screen in the preset manner, the method further comprises:
in response to failing to receive the first target image returned by the server, displaying the second target image on the current screen.

In an embodiment, displaying the at least two original images on the current screen in the preset manner comprises:
obtaining a playing animation respectively corresponding to the at least two original images; and
displaying the at least two original images on the current screen based on the playing animation.

In an embodiment, the playing animation comprises motion information and display information of original images in a screen, and displaying the at least two original images on the current screen based on the playing animation comprises:
displaying the at least two original images on the current screen based on the motion information and the display information, and wherein the motion information comprises position information and rotation information, and the display information comprises size information and transparency information.

In an embodiment, displaying the at least two original images on the current screen in the preset manner comprises:
obtaining preset materials; and
displaying statically the at least two original images based on a first transparency, and displaying the preset materials on the current screen based on a second transparency, wherein the first transparency is greater than the second transparency.

In an embodiment, after displaying the at least two original images on the current screen in the preset manner, the method further comprises:
in response to failing to receive the first target image returned by the server, displaying preset information on the current screen.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

1. A method of image processing, comprising:
obtaining at least two original images;
displaying the at least two original images on a current screen in a preset manner, and sending the at least two original images to a server, such that the server performs fusion processing on the at least two original images; and
receiving a first target image returned by the server, and displaying the first target image on the current screen, wherein the first target image is an image obtained after the server has performed the fusion processing on the at least two original images.

2. The method of claim 1, wherein obtaining the at least two original images comprises:
upon detecting a first operation triggered by a user, performing frame-capture processing on the current screen at least twice in succession, so as to obtain at least two original images; or
upon detecting that a user selects at least two original images locally and triggers a second operation, using the at least two original images selected by the user as the obtained at least two original images.

3. The method of claim 2, wherein obtaining the at least two original images comprises:
during performing the frame-capture processing on the current screen at least twice in succession, in response to detecting that the user selects at least two original images locally and triggers the second operation, stopping the frame-capture processing, and deleting images obtained through the frame-capture processing, and using the at least two original images selected by the user as the obtained at least two original images.

4. The method of claim 1, wherein sending the at least two original images to the server, such that the server performs the fusion processing on the at least two original images, comprises:
sending the at least two original images carrying an algorithm identifier to the server, such that the server calls a target fusion algorithm based on the algorithm identifier, so as to perform the fusion processing on the at least two original images using the target fusion algorithm.

5. The method of claim 4, when sending the at least two original images to the server, further comprising:
calling a locally preset algorithm to process any of the at least two original images, so as to obtain a second target image, wherein the locally preset algorithm corresponds to the target fusion algorithm.

6. The method of claim 5, wherein after displaying the at least two original images on the current screen in the preset manner, the method further comprises:
in response to failing to receive the first target image returned by the server, displaying the second target image on the current screen.

7. The method of claim 1, wherein displaying the at least two original images on the current screen in the preset manner comprises:
obtaining a playing animation respectively corresponding to the at least two original images; and
displaying the at least two original images on the current screen based on the playing animation.

8. The method of claim 7. wherein the playing animation comprises motion information and display information of original images in a screen, and displaying the at least two original images on the current screen based on the playing animation comprises:
displaying the at least two original images on the current screen based on the motion information and the display information, and wherein the motion information comprises position information and rotation information, and the display information comprises size information and transparency information.

9. The method of claim 1, wherein displaying the at least two original images on the current screen in the preset manner comprises:
obtaining preset materials; and
displaying statically the at least two original images based on a first transparency, and displaying the preset materials on the current screen based on a second transparency, wherein the first transparency is greater than the second transparency.

10. The method of claim 1, wherein after displaying the at least two original images on the current screen in the preset manner, the method further comprises:
in response failing to receive the first target image returned by the server, displaying preset information on the current screen.

11. (canceled)

12. An electronic device, comprising:
one or more processors; and
a memory configured to store one or more computer executable instructions;
wherein the one or more-programs computer executable instructions, when executed by the one or more processors, cause the one or more processors to:
obtain at least two original images;
display the at least two original images on a current screen in a preset manner. and send the at least two original images to a server, such that the server performs fusion processing on the at least two original images; and
receive a first target image returned by the server, and display the first target image on the current screen, wherein the first target image is an image obtained after the server has performed the fusion processing on the at least two original images.

13. A non-transitory storage medium comprising computer executable instructions, wherein the computer executable instructions, when executed by a processor of a computer, cause the processor to:
obtain at least two original images;
display the at least two original images on a current screen in a preset manner, and send the at least two original images to a server, such that the server performs fusion processing on the at least two original images; and
receive a first target image returned by the server. and display the first target image on the current screen, wherein the first target image is an image obtained after the server bas performed the fusion processing on the at least two original images.

14. The electronic device of claim 12, wherein the instructions to obtain the at least two original images comprise instructions to
upon detecting a first operation triggered by a user, perform frame-capture processing on the current screen at least twice in succession, so as to obtain at least two original images; or
upon detecting that a user selects at least two original images locally and triggers a second operation, use the at least two original images selected by the user as the obtained at least two original images.

15. The electronic device of claim 14, wherein the instructions to obtain the at least two original images comprise instructions to:
during performing the frame-capture processing on the current screen at least twice in succession, in response to detecting that the user selects at least two original images locally and triggers the second operation, stop the frame-capture processing, and delete images obtained through the frame-capture processing, and use the at least two original images selected by the user as the obtained at least two original images.

16. The electronic device of claim 12, wherein the instructions to send the at least two original images to the server, such that the server performs the fusion processing on the at least two original images comprise instructions to:
send the at least two original images carrying an algorithm identifier to the server, such that the server calls a target fusion algorithm based on the algorithm identifier, so as to perform the fusion processing on the at least two original images using the target fusion algorithm.

17. The electronic device of claim 16, wherein the instructions to send the at least two original images to the server further comprise instructions to:
call a locally preset algorithm to process any of the at least two original images, so as to obtain a second target image, wherein the locally preset algorithm corresponds to the target fusion algorithm.

18. The electronic device of claim 17, wherein the instructions further comprise instructions to cause the one or more processors to:
after displaying the at least two original images on the current screen in the preset manner:
in response to failing to receive the first target image returned by the server, display the second target image on the current screen.

19. The electronic device of claim 12, wherein the instructions to display the at least two original images on the current screen in the preset manner comprise instructions to:
obtain a playing animation respectively corresponding to the at least two original images; and
display the at least two original images on the current screen based on the playing animation.

20. The electronic device of claim 19, wherein the playing animation comprises motion information and display information of original images in a screen, and the instructions to display the at least two original images on the current screen based on the playing animation comprise instructions to:
display the at least two original images on the current screen based on the motion information and the display information, and wherein the motion information comprises position information and rotation information, and the display information comprises size information and transparency information.

21. The electronic device of claim 12, wherein the instructions to display the at least two original images on the current screen in the preset manner comprise instructions to:
obtain preset materials; and
display statically the at least two original images based on a first transparency, and display the preset materials on the current screen based on a second transparency, wherein the first transparency is greater than the second transparency.
